(19) United States
(12) Patent Application Publication
(10) Pub. No.: US 2007/0239653 A1
(43) Pub. Date: Oct. 11, 2007

(54) User interface morph based on permissions

(75) Inventor: Jesper Kiehn, Valby (DK)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/400,513

(22) Filed: Apr. 7, 2006

(51) Int. Cl. G06F 17/30

(52) U.S. Cl. 707/1

(57) ABSTRACT

Forms may be morphed based on permissions such that objects for which permission or a license is not available are not displayed. Relevant code may be analyzed to determine whether permission to a table is available and if permission to a table is not available, objects that rely on that table are not included in the morphed form.

### BACKGROUND

Computers are very useful at gathering, analyzing and displaying information. However, not all users are permitted to view all the applications or controls on a given system. Accordingly, if a user selects an item that is not licensed or has not been completely installed, nothing will happen which may be frustrating to a user.

### SUMMARY

Morphing a user interface based on permissions is disclosed. The method may create display forms to display a plurality of objects, use the objects to obtain permissions to display the individual objects, if permission is received for an object to be displayed, adding the object to a list of objects to be displayed, if permission is not received for an object to be displayed, refraining from adding the object to a list of objects to be displayed and creating a morphed display form that displays the objects in the list of objects to be displayed.

### DRAWINGS

FIG. 1 is a block diagram of a computing system that may operate in accordance with the claims;

FIG. 2 is a high level illustration of a method in accordance with the claims;

FIG. 3 is a more detailed illustration of a method in accordance with the claims;

FIG. 4 is a more detailed illustration of a method in accordance with the claims; and

FIG. 5 is an illustration of a display to be morphed.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

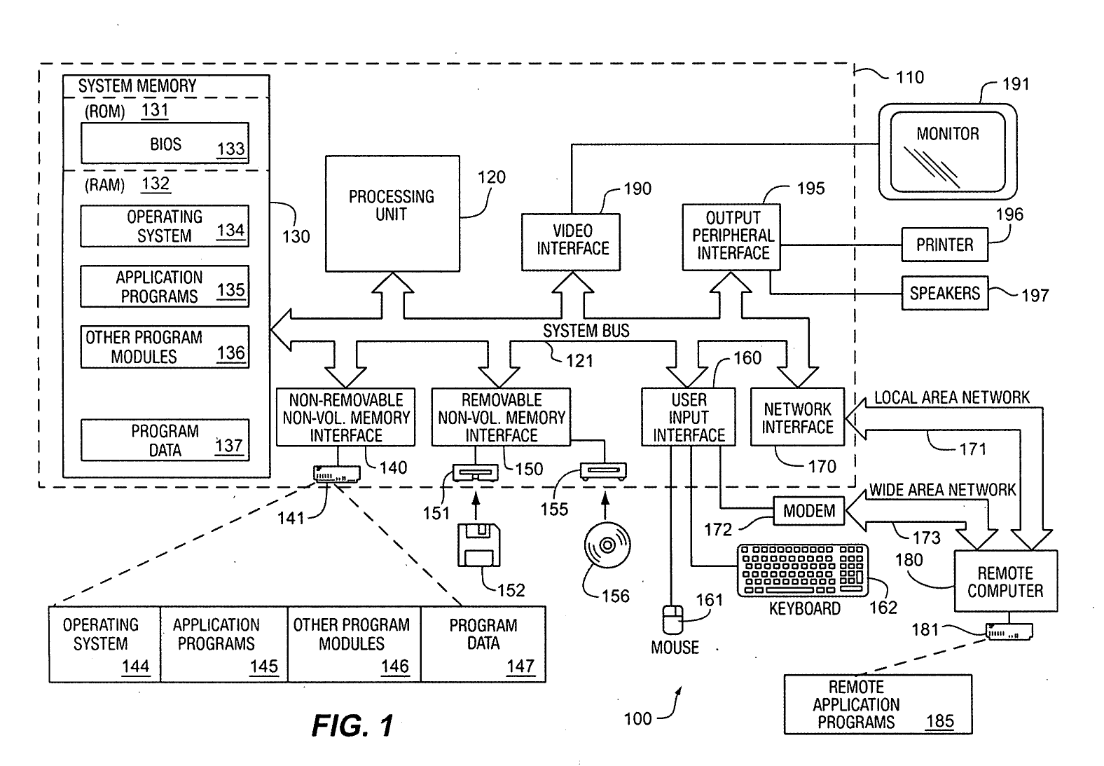

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start- up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

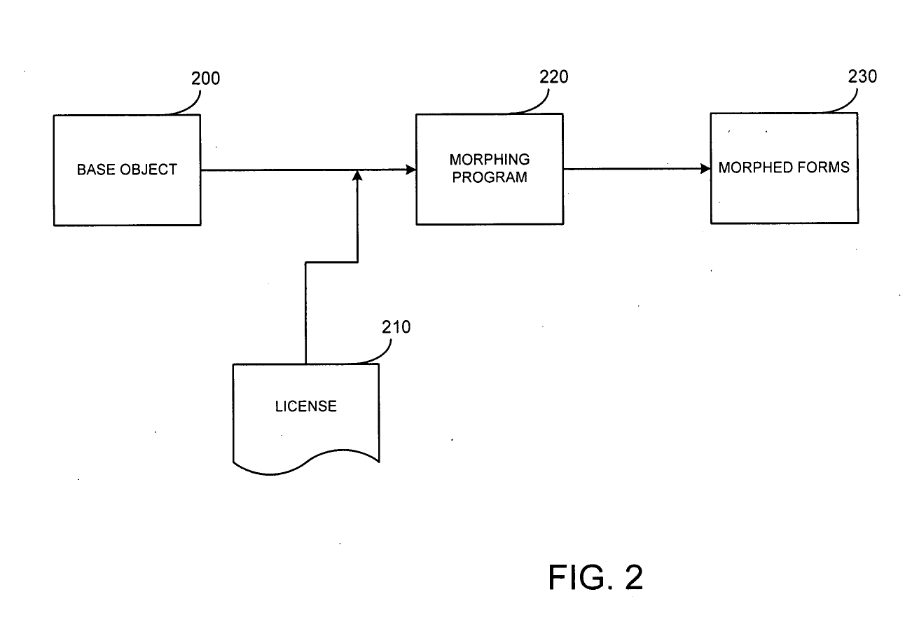

FIG. 2 may be a high level illustration of the blocks in a method of morphing a user interface. At block 200, objects that are to be displayed are gathered. Objects may be control object. For example, an object may be a display button to see personnel records that may be part of an additional module. Some firms may use the personnel module and other firms may not have purchased the rights to use the optional personnel module.

At block 210, the method may review the licenses that have been purchased. For example, some firms may have purchased the license for the personnel module while other firms may not have purchased the personnel module. This information is gathered and stored. The information may be stored as a positive file where items to be displayed are added to the positive list. In another embodiment, the information may be stored in a negative file where objects not to be displayed are stored. In yet another embodiment, both a negative list and a positive list may be used.

At block 220, the display objects and the license information is passed to a morphing program. The morphing program may take the license information and determine the objects that should be displayed and the objects that should not be displayed based in the license data received. The morphing program may then re-arrange the objects that are to be displayed into a logical arrangement so that the display still looks appropriate. For example, if some objects are not to be displayed and these objects normally occupy the left side of a task bar, the display may look lopsided unless some of the items to be displayed are moved to even out the task bar.

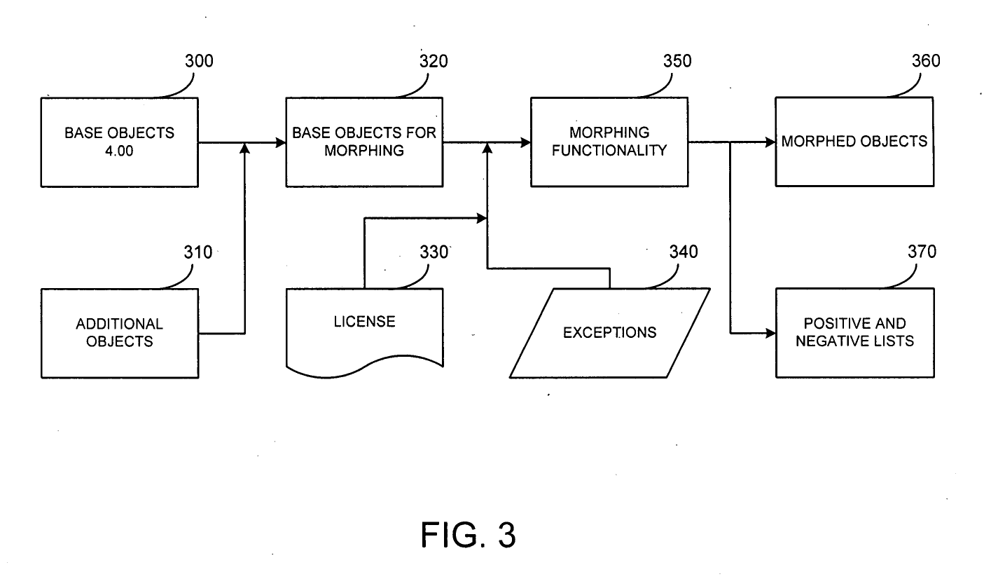

FIG. 3 may be a more detailed diagram of blocks of a method in accordance with the claims. At block 300, base objects are collected. The objects may be collected from a display program such as Navision from Microsoft. At block 310, additional objects may be added. The additional objects may be new features that have been developed such as new assistance related objects, etc. At block 320, the base objects from block 300 and the additional objects from block 310 may be combined such that all the possible objects that may be displayed are in a single file.

At block 330, license information may be gathered. The licenses may not be a physical license but a list of application granules to be included in the displayed application. Other program granules may be included that do not necessarily have a license associated with them. Granules may be thought of as program parts that add additional functionality to a base program like a personnel module is added on top of a General Ledger base program.

At block 340, a list of exceptions may be obtained. The list of exceptions may include all the field and other controls that the morph algorithm cannot identify or controls that are not needed because the feature or object will not be exposed.

At block 350, a morph tool may be executed. The morph tool may be an addition to a traditional display program such as Navision from Microsoft. Based on the licenses available from block 330, a list of field that are not relevant but still within the license are derived. Together, with the list of exceptions for what extra controls should be hidden, the morphing application generated versions of forms where the fields that are not relevant have been removed.

At block 360, the morphing tool may output a set of morphed objects for forms. These objects may be included in the next build of the software or they may simply be used instead of the original forms at runtime. The morphed objects may be stored in a database or the morphed objects may be stored as new objects. At block 370, the morphing tool may output a positive list of fields that enumerates all the fields that are visible as a positive list. The tool may also output a list of fields that are hidden as a negative list. The negative may also indicate why the fields are hidden such as a license is not available, an exception occurred, etc. Sample entries in the list may include the form number, a control number, a control type (such as textbox, menu button, input field, etc.).

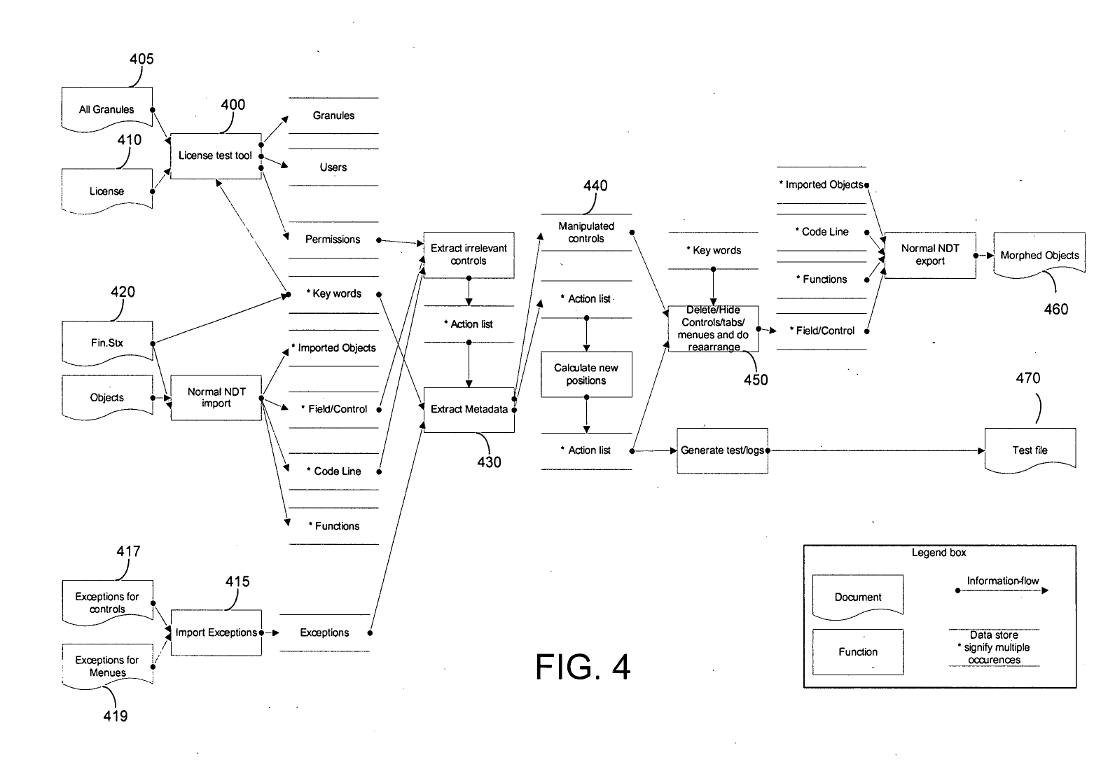

FIG. 4 may be yet another more detailed illustration of the method in accordance with the claims. At block 400, the method may start a license test tool. The license test tool may ensure that the license is configured correctly by simulation of the permissions such that a user can see the effect on the forms. The importation of the test data may occur without user knowledge. Program granules 405 may also feed to the license test tool 400 as does the license data 410. The license data 410 may import a license definition to be used as the basis for the morphing permission. After this data is imported, the user permissions records may be set up for a specific user. A sample license file may be as follows:

The file format is (CSV—semicolon separated):

| Enabled | SourceExpr | StartPos | Width |
|---|---|---|---|
| Yes | “Granule ID“ | 1 | 20 |
| Yes | “Granule Description” | 22 | 50 |
| Yes | “Required By” | 73 | 20 |
| Yes | “User ID” | 94 | 20 |

A comma separated file is a file formatted with semicolon or comma as separator between values. Each line consists of values for one record and lines are separated with carriage return linefeed. A CSV file can easily be exported from and imported into Excel for manipulation. At block 415, the method may import exceptions. The exceptions may be control exceptions 417 and menu exceptions 419. The exceptions may be stored as a comma separated value (CSV) file and may be of the form:

Form number (integer); x; x; x; ControlNumber (integer); x; x; x; Hide (yes/) where the “x” are ignored but may have useful information for the user.

At block 420, the STX file may be imported such that keyword in the System terminology file (“STX”) file may be identified and used in multi-language situations. The STX file may be a file that contains the text constants needed for the system to operate language independent. It may contain definition for yes, no and field names for system tables. The morph tool only uses objects and object properties, so there may not be other multi-language requirements than the following pieces:

| Code | STX code | Enum | Value |
|---|---|---|---|
| NO | 00133-01000-010-1 | 1 | NO |
| SUPER | 00019-00501-020-0 | 1 | SUPER |
| YES | 00133-01000-010-1 | 2 | YES |

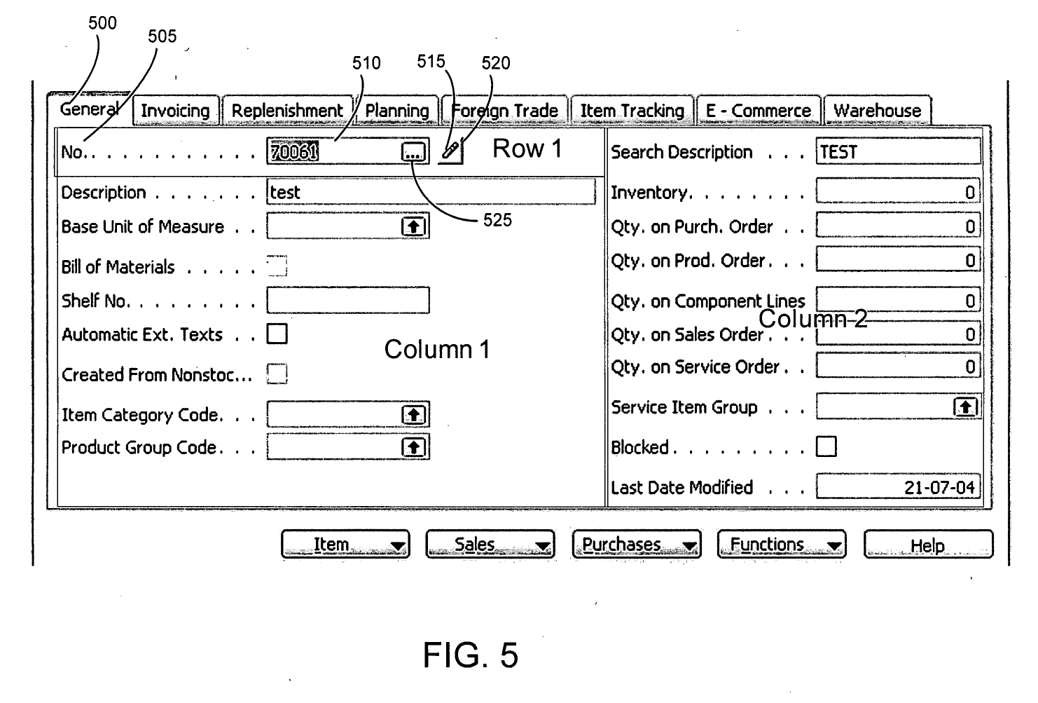

At block 430, metadata is extracted for controls such as pages and columns. In order for the method for moving controls to find out where to move the controls, it needs to know where the controls are located. Accordingly, the display is broken up into columns and rows. FIG. 5 may be an illustration of one such breakdown. For example, the “No” entry object 500 may be in the first row in the first column. In addition, the first row, first column may contain four objects: The label for “No.” 505, the textbox for No. 510, the bitmap for comments (the pencil illustration) 515; and the comment button itself 520. It should be noted that the assist edit button 525 is part of the textbox control and not a separate object. If controls overlap, the method may detect this situation and refrain from moving the controls.

In order for the algorithm to establish whether a given control is within the license it may be necessary to find what objects a control is using and then determining if all the objects are within the license. The analysis may have three steps. First, a table may be created for relations between controls and fields. Second, a table may be made for relations between fields and objects. Finally, a table may be made for relations between control and other objects. The method may analyze the relation between any controls on forms to tables and if a control only accesses a table that the user does not have permission to, then the code analyzer removes the control. Metadata may be used to indicate that objects should or should not be included.

Finding the controls that are manipulated may consist of finding all code within the current form that changes the properties of the form at runtime, i.e., code that contains the fragment currform.* or RequestOptionsForm.* followed by “.” “;” or another code separator such as a blank. The method may then examine whether the text fragment * is a valid control name for the form. All the controls that are manipulated may be listed in a table with the object type, object number, control number and name of the control. Manipulation of controls may also be obtained using metadata that is by having properties on the controls that are evaluated at execution time and then these properties are used to control the appearance of the controls. Finding the manipulated controls may then consist of finding the controls with metadata of the type that leads to run time changes of appearance.

Next, the method may hide controls that are not relevant or that have exceptions. More relevant remaining controls may then be moved on the form. Child controls of parents that are hidden may also be hidden. The hidden controls should be listed in a separate table. If a field has a multiple relation then the controls for that field may be hidden if all the relations are irrelevant.

At block 450, the method may remove controls that are hidden. Controls may be hidden if they are not manipulated and not marked to be hidden only in the exception list. If the control to be deleted is a textbox, image, picture, Boolean or other control that may have a child control, the child control may be deleted too.

Related, a control such as a tab page that contains no active controls may be deleted. A tab page may be a control that opens a new page if it selected. Controls that are on a tab page must be moved before the tab page can be deleted therefore the controls that are hidden on the tab page must be moved to another tab page before the tab page can be deleted. The method may delete empty tabs and move controls that are hidden but not deleted to the first tab available.

The method may disable or delete menu items that are not relevant. If the menu item have relations only to objects that are outside the license then the menu item may be deleted/hidden. Similarly, menus that are not relevant may be disabled or deleted. When all menu items within a menu, other than separators, have been disabled or deleted then the menu will appear to be without any function to the user and should then be deleted. Other menus may be moved to the direction of their properties, like a vertical glue property, such that the space between menus is maintained.

At block 460, new objects may be created. The main parts of the build process may be to obtain the base objects, obtain the morph objects, import the objects into a newly created database, execute the Morph manager that imports all necessary files such as license and granules and generates/morph forms, export morphed objects as text and run a build process with the morphed objects.

Test data 470 also may be created to ensure the method is working properly and to document the changes made by the method. The data for hidden fields may be exported in the following form:

Form no; Page name; Control no; Control Caption, type (menu/text/picture/ . . . ); License Access (Permissions according to license and granules. Yes/No); Exception List (Permissions according to exception list. Yes/No)

Example:

30; General; 8; “Bill of Materials”; CheckBox;Yes;Yes

The example illustrates that Bill of Materials Checkbox should be removed because there is not access through the field within the license. The second Yes also says that there is also an exception saying that this control should be deleted. The Control is places on the first tab page.

Column breakage:

A log may also be kept of situations where controls could not be moved because of overlap or where column definitions are broken. The list is a (CSV semicolon separated) list of controls that causes the Columns definitions to break.

Form no, Control No

The method may also keep track of the differences between base and morphed forms. In this way, improvements to the morph method may be tracked. In one embodiment, if the forms are stored as XML files, XML diff is used to compare to morphed forms of different versions.

The fields that have been morphed away from forms should also be morphed away from reports request forms filter fields. The previous process for Morphing have generated a table with the form, control no, Table no and field no and Field name. This table may be used to remove the request filter fields too. The table may contain both fields found by license check and the manual exceptions imported. If any form have removed a control with a field from a table this field should not appear on any reports request filter field either.

The user may still be able to add the field or other fields to the request filter fields because the fields are not deleted from the database. The purpose of the feature is only to ensure that no report will show the morphed fields on the list of filters by default.

In implementation, the controls to be morphed away may be read in from a CSV file. These controls may be removed from the option form in the same way as the controls on the normal forms. The manipulated controls must be hidden just like on normal forms and not deleted as this would generate compilation errors.

The option form must be rearranged in the same way as the normal forms to avoid “holes” and to follow the guide lines for design of forms. If the Option form becomes empty (no controls left), then the option form disappears automatically. This means that if some control is set to not visible because it is manipulated in code the Option Form might end up empty with no visible controls.

In one embodiment, the method is used with Navision from Microsoft Corporation. Navision helps companies integrate financial, manufacturing, distribution, customer relationship management, and e-commerce data. Referring again to FIG. 3, The base object 300 may be objects from Navision. Additional objects 310 may be additional objects developed by a feature team, or third parties specifically for Navision. The base objects 300 and additional objects 310 may be combined and may become the base objects for morphing 320. At block 330, license definitions may be stored. The license definition may not be a normal physical license but may be a list of application granuals to be included with the Navision application. The license definition may not need to include system granuals such as a forms designer but may include a list of granuals and the permissions these granuals contain. At block 340, exceptions may be stored which may be all the fields and other controls that the Morph algorithm cannot identify or controls that are not needed because the feature may not to be exposed. Block 350 may be the Navision Developers Toolkit with morphing functionality. Using the license data from block 330, a list of fields that are not relevant but still within the license may be derived. Together with the list of exceptions for what extra controls to hide, the morphing program generates versions of forms where the fields that are not relevant have been removed. At block 360, the output of the morphing tool may be a set of morphed objects for forms and may be included in the daily build. At block 370, a positive list and a negative list of fields to be displayed by Navision may be created.

In application, the Navision client and Navision Development Toolkit may share a database. The database may contain normal objects for the Morph process, objects from the Navision development toolkit that stores representations of the imported objects and other information needed by the Morph tool. The morphed objects may be stored as records in the database and not as objects. When the daily Navision build occurs, the system may get all the Navision Development Toolkit objects, get all the morph objects from the shared database and import the objects into a new database. The Navision development tool may import the base objects and the morph manager imports all the necessary files such as license and granual files and may generate the morphed forms. The morphed objects may be exported as text and Navision may run the build process using the morphed objects.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of morphing a user interface based on permissions comprising:
creating display forms to display a plurality of objects;
using the objects to obtain permissions to display the individual objects;
if permission is received for a first object to be displayed, adding the first object to a list of objects to be displayed;
if permission is not received for a first object to be displayed, refraining from adding the first object to a list of objects to be displayed; and
creating a morphed display form that displays the objects in the list of objects to be displayed.

2. The method of claim 1, wherein the object is a control object.

3. The method of claim 1, wherein the object has metadata and the permissions are stored in the metadata.

4. The method of claim 1, further comprising extracting the metadata from the object.

5. The method of claim 4, wherein extracting the metadata further comprises linking fields to other related tables and forms such that the license information that specify what tables a user has access to can be used to find the forms and fields a user should not have access.

6. The method of claim 1, further comprising using a code analyzer to analyze the relation between any controls on forms to tables and if a control only accesses a table the user does not have permission to, then the code analyzer removes the control.

7. The method of claim 1, further comprising determining whether a license is available for a second object and if the license for the second object is available, adding the second object to the list of objects to be displayed.

8. The method of claim 1, further comprising creating the forms at runtime.

9. The method of claim 1, further comprising creating a plurality of forms and based on the permissions, displaying one of the plurality of forms.

10. The method of claim 1, further comprising analyzing code to determine if an object uses a table to which a license is not present, and if a license is not present, eliminating the object.

11. The method of claim 1, the method further loads in program granules, analyses whether the objects in the granules are needed and generates morphed forms.

12. A computer readable medium that stores computer executable code for morphing a user interface based on permissions comprising:
computer executable code that creates display forms to display a plurality of objects where the object has metadata and the permissions are stored in the metadata.;
computer executable code that uses the objects to obtain permissions to display the individual objects;
if permission is received for a first object to be displayed, computer executable code that add the first object to a list of objects to be displayed;
if permission is not received for a first object to be displayed, computer executable code that refrains from adding the first object to a list of objects to be displayed; and
computer executable code that creates a morphed display form that displays the objects in the list of objects to be displayed.

13. The computer readable medium of claim 12, further comprising computer executable code for extracting the metadata from the object.

14. The computer readable medium of claim 13, wherein the computer executable code for extracting the metadata further comprises computer executable code that links fields to other related tables and forms such that the license information that specify what tables a user has access to can be used to find the forms and fields a user should not have access.

15. The computer readable medium of claim 12, further comprising computer executable code for analyzing the relation between any controls on forms to tables and if a control only accesses a table the user does not have permission to, then removing the control.

16. The computer executable medium of claim 12, further comprising computer executable code that determines whether a license is available for a second object and if the license for the second object is available, adds the second object to the list of objects to be displayed.

17. A computer system comprising
a processor,
a memory and
an input/output device,
the processor being capable of executing computer executable instructions and
the memory being capable of storing computer executable instructions;
the processor being programmed to execute computer executable code that creates display forms to display a plurality of objects where the object has metadata and the permissions are stored in the metadata.;
the processor being programmed to execute computer executable code that uses the objects to obtain permissions to display the individual objects;
if permission is received for a first object to be displayed, the processor being programmed to execute computer executable code that add the first object to a list of objects to be displayed;
if permission is not received for a first object to be displayed, the processor being programmed to execute computer executable code that refrains from adding the first object to a list of objects to be displayed; and
the processor being programmed to execute computer executable code that creates a morphed display form that displays the objects in the list of objects to be displayed.

18. The computer of claim 17, the computer executable code for extracting the metadata from the object wherein the processor being programmed to execute computer executable code for extracting the metadata further comprises:
the processor being programmed to execute computer executable code that links fields to other related tables and forms such that the license information that specify what tables a user has access to can be used to find the forms and fields a user should not have access.

19. The computer of claim 17, further comprising the processor being programmed to execute computer executable code for analyzing the relation between any controls on forms to tables and if a control only accesses a table the user does not have permission to, then removing the control.

20. The computer of claim 17, further comprising the processor being programmed to execute computer executable code that determines whether a license is available for a second object and if the license for the second object is available, adds the second object to the list of objects to be displayed.
